(19) United States
(12) Patent Application Publication
(10) Pub. No.: US 2003/0064294 A1
(43) Pub. Date: Apr. 3, 2003

(54) Pretreatment method for hologram recording medium

(75) Inventors: Kenji Kitamura, Tsukuba-shi (JP); Shunji Takekawa, Tsukuba-shi (JP); Masaru Nakamura, Tsukuba-shi (JP); Takashi Yamaji, Tsurugashima-shi (JP); Hideki Hatano, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Independent Administrative Institution National Institute for Materials Science, Tsukuba-shi (JP)

(21) Appl. No.: 10/235,853

(22) Filed: Sep. 6, 2002

(30) Foreign Application Priority Data
Sep. 7, 2001 (JP) P2001-272499

(51) Int. Cl. G03H 1/04

(52) U.S. Cl. 430/1; 430/2; 359/7; 430/394

(57) ABSTRACT

Disclosed is a pretreatment method for a hologram recording medium used in the hologram recording method in which information signals loaded on signal beam are recorded by injecting coherent signal beam and reference beam to the hologram recording medium which is exposed to first light having first wavelength of ultraviolet band or short-wavelength visible light band in advance in order to generate light-induced absorption, wherein the coherent signal beam and reference beam each having longer wavelength than the first wavelength. The pretreatment method comprises subjecting the hologram recording medium to oxidation treatment prior to the irradiation of the first light has been completed.

### BACKGROUND OF THE INVENTION

1. Field of the Invention

This invention relates to a pretreatment for hologram recording medium, particularly, a pretreatment for improving characteristics of the hologram recording medium using the reversible photochromism wherein coloring is caused in advance by irradiating ultraviolet or short-wavelength visible light, and decolorization is caused by visible light irradiation. Further, this invention relates to a hologram recording method and a hologram recording device using such hologram recording medium.

2. Related Art

Holographic memory system has been known in the art as digital recording system to which the principal of the holography is applied. In the following, the outline of holographic memory system is explained by the reference of FIG. 1. In FIG. 1, an encoder 25 converts digital data to be recorded in holographic storage medium 1 into a light-dark dot pattern image on a plane. The data is arranged, for example, to a data arrangement of 480 bits length×640 bits width so as to produce unit page series data is made. This data is sent out to a spatial light modulator (SLM) 15, such as the panel of transmission TFT liquid crystal display (LCD).

The spatial light modulator 15 has a modulation processing unit of 480 pixels length×640 pixels width corresponding to the unit page, modulates irradiated light beams to spatial light on/off signal with corresponding to the unit page series data from encoder 25, and leads the modulated signal beam, namely, the signal beam, into a lens 16. In detail, the spatial light modulator 15 makes the signal beam pass in response to logical value “1” of series data in the unit page which is electric signal, and make signal beam cut off in response to logical value “0”. Thereby, electro-optics modulation with the each bit content in the unit page data is achieved, and modulated signal beam as signal of the unit page series is generated.

Signal beam is injected through lens 16 to the holographic storage medium 1. In addition to the signal beam, reference beam is also injected to the holographic memory, with an incidence angle a from the prescribed base line which crosses perpendicularly with the optical axis of the signal beam. Thus, interference between the signal beam and the reference beam arises within the holographic storage medium 1. The resultant interference pattern is recorded as refractive index lattice, namely, hologram, so that the data is recorded in the holographic storage medium 1. Three-dimensional data recording is also made possible by injecting two or more reference beams with varied incidence angles a for angularly multiplexed recording of plural two-dimensional plane data.

When the recorded data is reconstructed from holographic storage medium 1, only the reference beam is injected to the holographic storage medium 1 with the same incidence angle a as that used during recording, by directing the reference beam toward the center of the region where signal beam and reference beam cross each other. Accordingly, the signal beam is not irradiated at reproduction in contrast to the recording. As a result, diffraction light from the interference pattern recorded in the holographic storage medium 1 is led to CCD (Charge Coupled Device) of the light detector through the lens 19. The CCD 20 converts the variations of light and dark in the incident light to the intensity of electric signal, and outputs to the decoder 26 the obtained analog electric signal of a level in proportion to the brightness of the incidence light. The decoder 26 compares this analog signal with the prescribed amplitude value (slice level), and reconstructs corresponding data of “1” or “0”.

Conventionally, regarding rewritable type holographic storage medium 1 using the photorefractive effect, Fe doped lithium niobate (LiNbO₃, abbreviated as LN) single crystal is used usually as a recording material thereof, and wavelength of 532 nm which is the second harmonic of Nd:YAG laser as the recording beam. In this conventional type recording method, referred to “conventional type single color recording method” hereinafter, in the bright region of the interference pattern, electrons are excited to the conduction band from the level of Fe²⁺ by corresponding with the interference pattern formed by the recording beams, i.e., signal beam and reference beam. Finally, the electrons are trapped at the level of F³⁺ through photorefractive process to complete storage.

However, when the signal thus recorded is readout from the hologram, the reconstruction beam tends to erase the hologram gradually. Against this problem (reconstructive degradation), a 2-color hologram method has been proposed as one of recording methods with lesser reconstructive degradation. In 2-color hologram, the hologram is recorded by simultaneously irradiating another light, called gate beam (wavelength λ2), in addition to the recording light (wavelength λ1, reference beam and signal beam) which forms hologram. The effect of the gate beam is to generate recording sensitivity in the wavelength (λ1) only during irradiation of the gate beam. Such a feature comes from that only in the region where the gate beam is irradiated, carriers are formed temporally at relative shallow energy level, called medium excitation level, in the crystal. These carriers at the medium excitation level are excited by the recording light, which is spatial light-dark pattern corresponding to the interference pattern formed by the reference beam and the signal beam, and the recording is completed by finally allowing the excited carriers to be accumulated at deep trap level in the form of concentration distribution of the carriers corresponded to the interference pattern. The latter step of this method is a step called photorefractive effect, which is based on the same principle as that of the single color hologram. For example, in the case of 2-color hologram recording method, the life time of the carrier at this medium excitation level (metastable level) can be prolonged to the time scale from micro seconds to several seconds by using the crystal made by reducing pure or Fe-doped LiNbO₃ with nearly stoichiometric composition (abbreviated to SLN) (H. Guenther, R. M. Macfarlane, Y. Furukawa, K. Kitamura; “2-color holography in reduced near-stoichiometric lithium niobate”, Appl. Opt. Vol. 37, pp. 7611-7623 (1998)), which enabled to record nonvolatile holograms using relative low power laser of continuous oscillation.

In the case of 2-color hologram recording method based on bipolaron-polaron mechanism, photorefractive center density needs to be increased by reducing the recording material. Accordingly, it caused a problem that the density of Fe³⁺ decreased and thereby transparency of the material itself became inferior. Further, considering the level of practical use, the light sensitivity is insufficient, thus, the hologram recording method with higher sensitivity has been desired.

Moreover, for the 2-color hologram recording method, when the life time of the carriers at the medium excitation level is too long, the carriers remain existed for a several time depending on the life time at that level after recording, and the carriers are excited to the conduct band again by the reading beam. Consequently, the spatial electrical field which has already been formed was cancelled by these carriers, and as a result diffraction efficiency was lowered.

From such aspects, for the purpose of providing a recording method having a good recording sensitivity, and an excellent nondestructive property of data such as being low signal degradation during the reconstruction, we have proposed a hologram recording method in which information signal loaded on a signal beam are recorded by injecting a coherent signal beam and a reference beam to a hologram recording medium which generates light-induced absorption when it is exposed to the first light of the first wavelength of ultraviolet band or short-wavelength visible light band, e.g. Tb and Fe doped lithium niobate single crystal, and which method is characterized by comprising a step of irradiating the hologram recording medium with the first light, and a step of irradiating the medium with a signal beam and a reference beam each having longer wavelength than the first wavelength after irradiating the first light (JP 2001-66977 A).

According to this method, at the recording, since the hologram recording medium is colored by irradiating ultraviolet etc., the recording sensitivity can be enhanced. Further, since the medium is decolorized by irradiating the signal beam and the reference beam each having longer wavelength than said first wavelength, the sensitivity becomes lowered and the erasure time constant also becomes increased after the completion of recording, thus, the data destruction caused by the reconstruction beam can be decreased.

However, even if using this method, the sensitivity has been still remained in the hologram recording medium after the completion of recording. Therefore, this method can stand further improvement for aspects of recorded data destruction caused by the reconstruction beam and decrease of the multiple recording properties.

### SUMMARY OF THE INVENTION

Accordingly, an object of this invention is to provide a method for improving properties of the hologram recording medium using reversible photochromism which allows to colorize by pre-irradiation of ultraviolet or short-wavelength light and allows to decolorize by irradiation of visible light. Further, another object of this invention is to provide a hologram recording method and a hologram recording device which are intended to lower the sensitivity of hologram recording medium after recording is completed, to prevent destruction of recorded data by irradiation of the reconstruction beam, and to improve the multiplexed recording property.

To solve the above-mentioned objects, this invention provides a pretreatment for a hologram recording medium used in the hologram recording method in which information signals loaded on signal beam are recorded by injecting coherent signal beam and reference beam to the hologram recording medium which is exposed to first light having first wavelength of ultraviolet band or short-wavelength visible light band in advance in order to generate light-induced absorption, wherein the coherent signal beam and reference beam each having longer wavelength than the first wavelength, which pretreatment comprising subjecting the hologram recording medium to oxidation treatment prior to the irradiation of the first light.

In the pretreatment method for hologram recording medium according to this invention, the recording medium may be preferably a photorefractive material which is selected from the group consisting of lithium niobate (LiNbO₃) single crystal comprising transition metal and rare-earth element and/or Hf, having molar fraction of [Li₂O]/[LiO₂]+[Nb₂O₅] in the range of 0.482-0.505; and lithium tantalate (LiTaO₃) single crystal comprising transition metal and rare-earth element and/or Hf, having molar fraction of [Li₂O]/[LiO₂]+[Nb₂O₅] in the range of 0.482-0.505.

Further, in the pretreatment for hologram recording medium according to this invention, preferably, the oxidation treatment is a heat treatment of 800-1150° C.

Further, in the pretreatment for hologram recording medium according to this invention, preferably, the oxidation treatment is that uses the oxidation function of transition metal added Tb as the rare-earth element.

Moreover, to solve the above-mentioned objects, this invention provides a hologram recording method in which information signals loaded on signal beam are recorded by injecting coherent signal beam and reference beam to the hologram recording medium which is exposed to first light having first wavelength of ultraviolet band or short-wavelength visible light band in advance in order to generate light-induced absorption, wherein the coherent signal beam and reference beam each having longer wavelength than the first wavelength, which method comprises a step of subjecting the hologram recording medium by oxidation treatment, a step of irradiating the oxidation treated hologram recording medium with the first light, and a step of irradiating the hologram recording medium with the signal beam and reference beam each having longer wavelength than said first wavelength after irradiating of the first light has been completed.

Furthermore, to solve the above-mentioned subjects, this invention provides a hologram recording device in which information signals loaded on signal beam are recorded by injecting coherent signal beam and reference beam to the hologram recording medium which is exposed to first light having first wavelength of ultraviolet band or short-wavelength visible light band in advance in order to generate light-induced absorption, wherein the coherent signal beam and reference beam each having longer wavelength than the first wavelength, which device comprises a means for oxidizing the hologram recording medium, a means of irradiating the hologram recording medium with the first light, and a means of irradiating the hologram recording medium with the irradiating signal beam and reference beam each having longer wavelength than said first wavelength after the first light irradiation.

### BRIEF DESCRIPTION OF THE DRAWINGS

FIG. 1 is a construction diagram showing a conventional hologram recording system;

FIG. 2 is a construction diagram showing hologram recording and reconstructing device according to this invention;

FIG. 3 is a graph showing the change of light sensitivity due to the oxidation-reduction state (Fe ionized state) of the recording medium, corresponding to just after the ultraviolet light irradiation (colorized state) and after the completion of recording (decolorized state) in an Example of this invention; and

FIG. 4 is a graph showing the change of erasure time constant due to the oxidation-reduction state (Fe ionized state) of the recording medium, corresponding to just after the ultraviolet light irradiation (colorized state) and after the completion of recording (decolorized state) in an Example of this invention

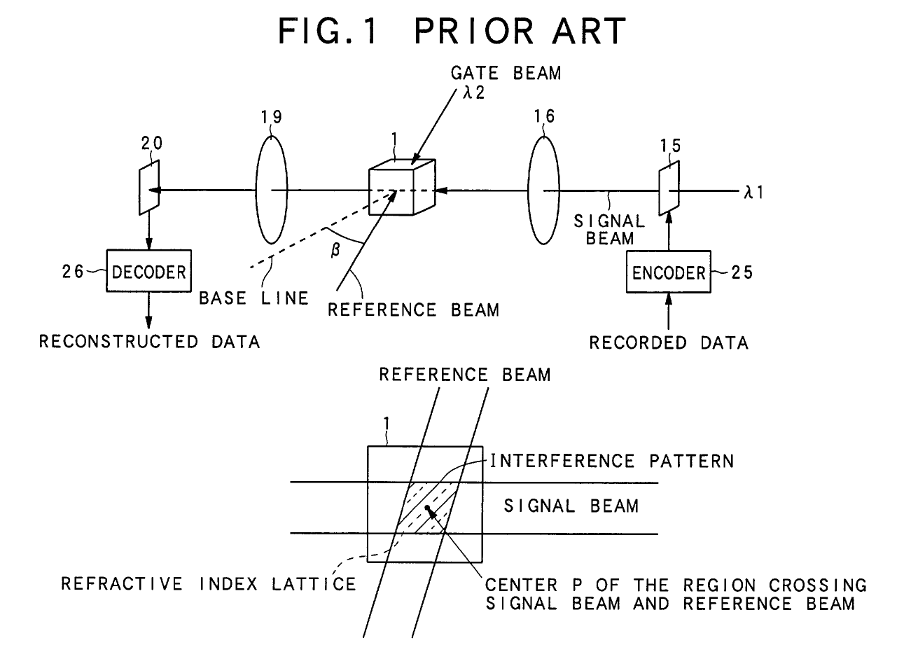

### PREFERRED EMBODIMENTS OF THE INVENTION

Now, embodiments of this invention will be described as follows.

The hologram recording method of this invention uses photochromism in which the hologram recording medium is photosensitized and colorized by irradiation of first light of first wavelength of ultraviolet band or short-wavelength visible light band, and then the medium is decolorized by irradiation of recording light having longer wavelength than the first wavelength, e.g. visible light having longer wavelength. There is a relationship that “as absorption coefficient increases, the sensitivity increases and erasure time constant becomes lowered” between absorption coefficient and sensitivity/erasure time constant. Using this property, at the recording, recording is carried out after irradiating ultraviolet etc., and enhancing sensitivity. Since decolorization is caused by the recording light (visible light having longer wavelength), when recording has been completed, the sensitivity of medium becomes lower and the erasure time constant also becomes larger. Consequently, it can be possible to decrease destruction of recorded data by reconstruction beam.

Further, as a result of our diligent studies, for the hologram recording method using such a step of irradiation of ultraviolet etc. as the first light, i.e., so called “pre-irradiation”, it was appeared that the properties of the recording medium had been changed as follows, when the recording medium received oxidation-reduction treatment.

Namely, after the reduction treatment, breadth of absorption change becomes smaller since absorption at the record wavelength increases and becomes the same level as after irradiation of ultraviolet etc. And after oxidation treatment, difference of absorption between before and after irradiation of ultraviolet etc. becomes great, since absorption at the record wavelength before irradiation of ultraviolet etc. decreases, while absorption after irradiation of ultraviolet etc. does not change greatly.

Accordingly, as this invention, absorption of recording medium can be decreased by oxidizing the recording medium as the pretreatment, and which allows the sensitivity to become lower after the recording has been completed, and allows the erasure time constant to enhance. Consequently, it can be possible to decrease destruction of the recorded data by the reconstruction beam.

Recording medium which can be used in this invention is a photorefractive crystal for hologram recording medium which generate light-induced absorption by exposure to the first light having the first wavelength in ultraviolet band or short-wavelength visible light band. As such photorefractive crystal, preferred is lithium niobate (LiNbO₃) single crystal containing transition metal and rare-earth element and/or Hf, having molar fraction of [Li₂O]/[LiO₂]+[Nb₂O₅] in the range of 0.482-0.505; or lithium tantalate (LiTaO₃) single crystal containing transition metal and rare-earth element and/or HF, having molar fraction of [Li₂O]/[LiO₂]+[Nb₂O₅] in the range of 0.482-0.505. As the transition metal, for example, Fe, Cu, Mn, Ni, Rh, Co, Ir, Pt, Mo, Cr etc., can be added, above all, Fe or Mn is more preferred, and Fe is most preferred. Further, as the rare-earth element and/or Hf, such rare-earth element as Tb, Pr etc., or Hf can be added, above all, Tb is more preferred. The addition amount of the transition metal is preferred in the range of 1 wt ppm-500 wt ppm, while the addition amount of the rare-earth element and/or Hf is preferred in the range of 10 wt ppm-1000 wt ppm.

Further, when Fe, Mn, Cr etc., especially Fe is doped as the transition metal, lithium niobate or lithium tantalate composed by co-doping Tb or Pr as rare-earth element can improve the properties since Tb or Pr causes oxidation effect to these transition metal to generate the oxidation treatment effect as the pretreatment of this invention. Further, such properties can be further improved by using oxidation treatment due to heating together.

With respect to the method of oxidation treatment as the pretreatment, there is no limitation particularly. Because, once transition metal doped Fe etc. comes to oxidized condition even to a slight extent, improved properties can be expected. However, a method is preferred, where not less than 50%, more preferably, not less than 90% of total amount of the transition metal is oxidized. Concretely, a heat treatment of 900° C.-1100° C. under oxidation atmosphere, or oxidation effect generated by Tb addition or Pr addition etc can be mentioned. Preferred processing time for the above-mentioned heat treatment may be, but not limited to, for example, 1-12 hours, more preferably 4-8 hours. The oxidation atmosphere may be that including oxygen, and thus, in addition to the heat treatment under pure oxygen atmosphere, or oxygen rich atmosphere, the treatment under atmosphic air can be adapted.

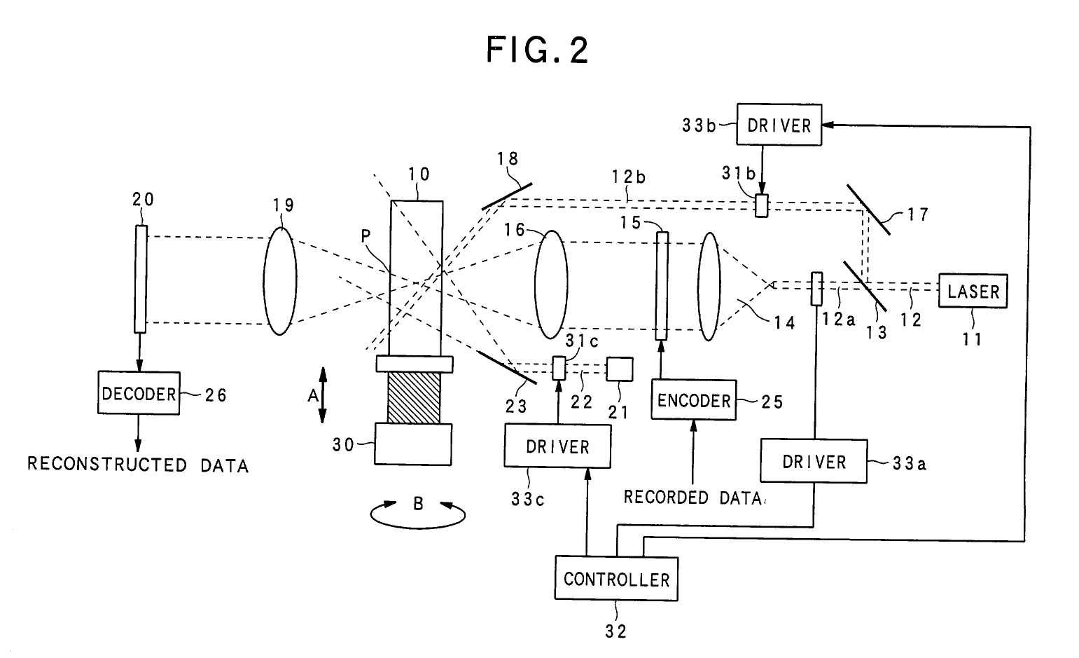

FIG. 2 is a construction diagram showing hologram record reconstructing device according to this invention.

The device construction in this example is the same with the conventional hologram recording device using, for example, signal beam and reference beam having wavelength of 532 nm, except equip an oxidation treating part which processes the pretreatment (not shown) and an irradiation part for ultraviolet band or short-wavelength visible light band. This irradiation part may be incorporated to the main body of the device to emit through a light shutter, etc., or may be settled as a separate unit from the hologram recording device.

In the hologram recording method, the irradiation step of ultraviolet, so called pre-irradiation, corresponds to an initializing step of recording material 10 which is performed before irradiation of signal beam and reference beam. Therefore, after the pretreatment which is oxidation treatment as mentioned above, pre-irradiation of ultraviolet for a prescribed time to initialize the material is performed, and thereafter the recording and reproducing is carried out according to method for conventional hologram recording reproducing device. According to this invention, because of erasing effect during the multiple recording can be decreased, the easing of scheduling design can be permitted in scheduling etc. for recording time during multiple recording, in contrast to those of the conventional type recording.

As shown in FIG. 2, the pre-irradiation light source 21 which is laser light source of first wavelength in ultraviolet band or short-wavelength visible light band, for example, 313 nm ultraviolet laser light source, has a power enough to cause light derived absorption of the recording medium 10 by its irradiation light to colorize immediately. Pre-irradiation light 22 emitted from pre-irradiation light source 21 passes through shutter 31c, and is refracted against mirror 23, and then is directed to the whole body of recording medium 10, or at least the hologram recording part thereof. Shutter 31c is established for opening and shutting optical path of pre-irradiation light 22. The opening and shutting of shutter 31c is driven by signal sent out from controller 32 with using driver 33c. As the light source, light source which is capable of spot irradiation by stopping down the beam diameter into position P inside the recording medium 10 is also used.

The light source of longer wavelength 532 nm (second wavelength) than the first wavelength 313 nm, for generation of signal beam and reference beam, maybe composed by YAG-SHG. Laser light 12 emitted from laser light source 11 is split into signal beam 12a and reference beam 12b by beam splitter 13. The same position P inside recording medium 10 is irradiated with signal beam 12a and reference beam 12b after passing through separate optical paths.

On the optical path of signal beam 12a, shutter 31a, beam expander 14, LCD 15, and 4f Fourier transform lens system 16 are located. Shutter 31a is installed for opening and shutting the optical path of signal beam 12a The opening and shutting of shutter 31a is driven by the signal sent out from controller 32 by using driver 33a. Beam expander 14 expands the beam diameter of signal beam 12a that has passed through shutter 31a in order to make the signal beam 12a parallel to irradiate the signal beam 12a to LCD 15. LCD 15 of the spatial light modulator receives electrical data of unit page system corresponding to two-dimensional plane page which has been given from encoder 25 to exhibit dot matrix signal of light-dark. Signal beam 12a suffers light modulating during passing through LCD 15 to include data as dot matrix component. Further, signal beam 12a allows the dot matrix component to undergo Fourier transform by the 4f Fourier transform lens system 16, then condensed so as to let the light be focused slightly in front of (in the side of laser light source 11) or in the rear of the position P of the recording medium 10

Reference beam 12b split from signal beam 12a by beam splitter 13 is introduced to the position P of the recording medium by mirror 17 and 18. Shutter 31b is arranged between mirror 17 and 18, which enables to open and shut the light path of reference beam 12b. The opening and shutting of shutter 31b is driven by the signal sent out from controller 32 by using driver 33b.

Moreover, an inverse Fourier transform lens 19 and CCD 20 as light receiver are arranged in the opposite side from the side where laser light source 11 is injected, when considering the rotation axis of cylindrical recording medium 10 as the center. To CCD 20, an analyzer for decoding the dot matrix signal of brightness is installed. Inverse Fourier transform lens 19 is arranged at the position where the signal beam 12a that focuses near the position P of recording medium 10 and where the arriving crossed signal beam 12 is modified to be parallel so as to go toward CCD 20 as parallel beam. Decoder 26 is connected to CCD 20. Further, in case that a label corresponding to the kind of photorefractive crystal is attached to the recording medium 10 in advance, once recording medium 10 is placed on mobile stage 30, this label is readout automatically by a proper sensor, and thus controller 32 can control a vertical motion and rotary motion of the recording medium based on the read information.

In such a construction of the device, light interference pattern of the reference beam and signal beam is formed in recording medium 10, finally the pattern is recorded as change of refractive index. On the other hand, for reconstruction of the information, the recording medium 10 is irradiated only with reference beam 12b, while signal beam 12a is cut by shutter 31a. At the side of recording medium 10, opposite to another side to which recording beam is irradiated, interference pattern reappears as reproduction of the recorded light interference pattern. The light interference pattern can be inverse Fourier transformed by introducing the interference pattern light into inverse Fourier transform lens 19 in order to obtain the dot pattern signal. Further, the light receiver of CCD 20 receives this dot pattern signal, and the signal is retransformed to electrical digital data signal and sends out to the decoder, then original data is reconstructed.

The feature of this invention consists in using recording material processed by oxidation treatment in advance and exhibits light derived absorption (photochromism). LiNbO₃ (or LiTaO₃) single crystal having near stoichiometric composition to which a transition metal such as Fe and rare-earth element such as Tb are added exhibits very large light derived absorption when ultraviolet light having wavelength of around 313 nm is irradiated thereto. This happens because carrier is exited from light absorption center (donor level) existing at near valance band and trapped to trap center (intermediate level), wherein the depth of the intermediate level is calculated with about 1.9 eV. This trapped carrier is re-excited by the light of the wavelength which is shorter than 650 nm, and has the reversibility of returning to the original donor level. Using these features, it is possible to record hologram with laser light of about 532 nm to the recording material made by irradiating the ultraviolet near the 313 nm wavelength in advance, colorizing, and filling the carrier in intermediate level.

In the part to where the ultraviolet light is irradiated, the carrier of the intermediate level is excited, when recording material is irradiated with the pattern of the spatial light-dark in proportion to the interference pattern formed by reference beam and signal beam of the 532 nm wavelength. Excited carrier recombines with the acceptor of the level close to the valance band at a dark section, consequently the spatial density distribution of the carrier in proportion to interference pattern is finally formed, and the spatial electric field is formed. By this course, the record of the interference pattern (hologram) is completed as a refractive index fluctuation in the crystal having the electro-optics effect.

Features of this invention greatly differentiated from the conventional technique are as follows:

(1) using stichiometric lithium niobate or stoichiometric lithium tantalate which is oxidized in advance as pretreatment, and shows a differentiation of absorption when compared before and after irradiation of ultraviolet etc.

(2) making stable and colorized stichiometric lithium niobate or stoichiometric lithium tantalate by irradiating ultraviolet (ultraviolet light) after the pretreatment, in advance of recording step, and

(3) not allowing the data to be destroyed even if the data is readout with reference beam as a part of writing light (for example 532 nm) once recording has been completed.

By these features, when the hologram recording material and recording method of this invention is used, it is possible to carry out the hologram recording of the amply satisfied non-destructive readout even with single color recording scheme.

### EXAMPLE

Using a double crucible single crystal growth equipment provided with continuous raw material supplying system, a melt having composition of [Li₂O]/([LiO₂]+[Nb₂O₅])=0.56-0.60 is added with Tb of 140 wt ppm and Fe of 25 wt ppm. From the resultant melt, optically excellent stoichiometric single crystal (Tb, Fe-doped SLN)having mole fraction [Li₂O]/([Ta₂O₅]+[Li₂O]) of 0.495-0.50 was grown.

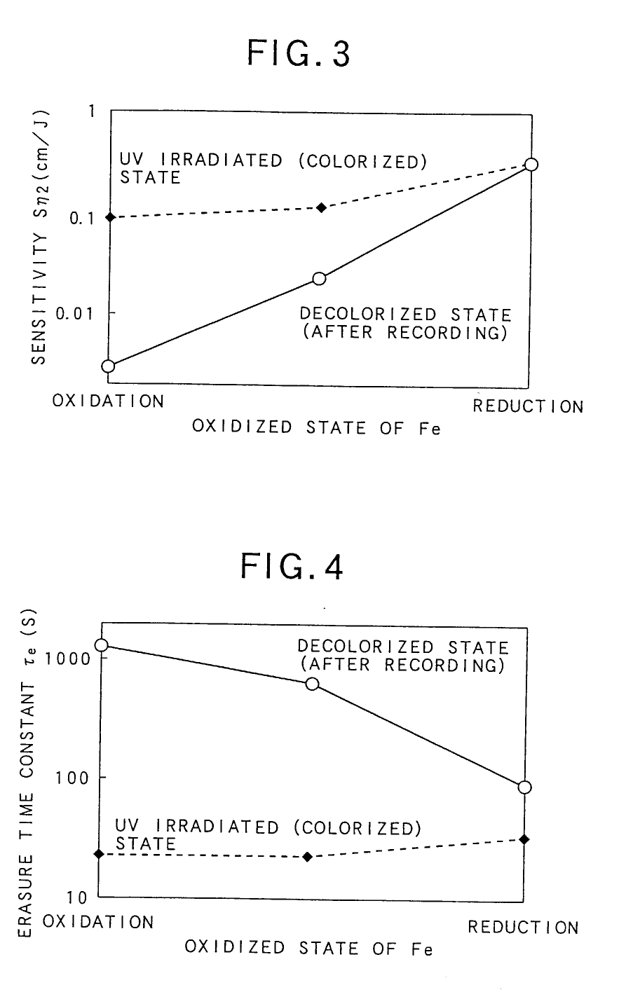

The obtained as-grown single crystal (3.3 mm in thickness) was heat treated at 950° C. for 1 hour under oxygen atmosphere, and properties of heat treated crystal was compared with those of non-heat treated one. Evaluation of the properties was carried out by measuring photorefractive-related parameters, after irradiating ultraviolet of 313 nm to the crystal, and recording plane-wave multiplexed holograms by angular multiplexing method to the resulting colorized crystal using 532 nm laser light (at 300 mW/cm², the direction of polarization was parallel to the c axis). FIG. 3 shows light sensitivity change caused by oxidation-reduction state (Fe ionized state) of the recording medium corresponding to just after irradiating ultraviolet (colorized state) and after recording has been completed (decolorized state). FIG. 4 shows erasure time constant change caused by oxidation-reduction state (Fe ionized state) of the recording medium corresponding to just after irradiating ultraviolet (colorized state) and after recording has been completed (decolorized state). In FIGS. 3 and 4, the horizontal axis means oxidation-reduction state of the recording medium for both figures, and the vertical axis in FIG. 3 means the sensitivity, and in FIG. 4 erasure time constant. And the solid line shows decolorized state after recording has been completed, and the broken line shows colorized state just after irradiating ultraviolet. By the way, before the oxidation treatment, this recording medium had shown intermediate state between oxidized state and reduced state.

In order to reduce the destructive readout recorded data, it is necessary to lower the sensitivity and increase the erasure time constant at the decolorized state. As shown in FIGS. 3 and 4, by oxidation treatment, the sensitivity at decolorized state was lowered by about one order of magnitude, and the erasure time constant was increased about twofold. This change tends to be desirable.

Contrary, at the colorized state after irradiating ultraviolet, it is preferable that the sensitivity is high. After the recording medium has been oxidized, the sensitivity lowered by about 10%, but it did not lower greatly as the sensitivity after decolorizing. Therefore, the data recording is not inferior greatly as compared with that before oxidizing. Consequently, because of the fact that, in the oxidized state, the difference of the sensitivity before and after the ultraviolet irradiation can take greatly and the erasure time constant during decolorizing can be enhanced as compared with those before the oxidation, it was found that the multiple recording property was improved and nonvolatile recording property was improved.

As described above, according to this invention, in the hologram recording by allowing record material, which has been colorized by irradiating short-wavelength light in advance and has been filled by carriers in its intermediate level, to effect laser light having longer wavelength than the short-wavelength light, it is possible to improve multiplexed recording property and improve nonvolatile property of recording by adding such simple treatment as processing the recording medium by oxidation treatment in advance.

The entire disclosure of Japanese Patent Application No. 2001-272499 filed on Sep. 7, 2001, including specification, claims, drawings and summary are incorporated herein by reference in its entirety.

What is claimed is:

1. Pretreatment method for a hologram recording medium used in the hologram recording method in which information signals loaded on signal beam are recorded by injecting coherent signal beam and reference beam simultaneously to the hologram recording medium which is exposed to first light having first wavelength of ultraviolet band or short-wavelength visible light band in advance in order to generate light-induced absorption, wherein said coherent signal beam and reference beam each having longer wavelength than the first wavelength,
said pretreatment method comprising subjecting the hologram recording medium to oxidation treatment prior to the irradiation of the first light.

2. Pretreatment method according to claim 1, wherein said recording medium is a photorefractive material which is selected from the group consisting of lithium niobate (LiNbO₃) single crystal containing transition metal and rare-earth element and/or Hf, having molar fraction of [Li₂O]/[LiO₂]+[Nb₂O₅] in the range of 0.482-0.505; and lithium tantalate (LiTaO₃) single crystal containing transition metal and rare-earth element and/or HF, having molar fraction of [Li₂O] [LiO₂]+[Nb₂O₅] in the range of 0.482-0.505.

3. Pretreatment method according to claim 1, wherein the oxidation treatment is a heat treatment in oxidation atmosphere with temperature of 800-1150° C.

4. Pretreatment method according to claim 1, wherein the oxidation treatment is that uses the oxidation function of transition metal by added Tb or Pr as the rare-earth element.

5. Hologram recording method in which information signals loaded on signal beam are recorded by injecting coherent signal beam and reference beam to the hologram recording medium which is exposed to first light having first wavelength of ultraviolet band or short-wavelength visible light band in advance in order to generate light-induced absorption, wherein said coherent signal beam and reference beam each having longer wavelength than the first wavelength,
said method comprises a step of subjecting the hologram recording medium to oxidation treatment, a step of irradiating the oxidation treated hologram recording medium with the first light, and a step of irradiating the hologram recording medium with the signal beam and reference beam each having longer wavelength than said first wavelength after irradiating the medium with the first light has been completed.

6. Hologram recording device in which information signals loaded on signal beam are recorded by injecting coherent signal beam and reference beam to the hologram recording medium which is exposed to first light having first wavelength of ultraviolet band or short-wavelength visible light band in advance in order to generate light-induced absorption, wherein the coherent signal beam and reference beam each having longer wavelength than the first wavelength,
said device comprises a means for oxidizing the hologram recording medium, a means of irradiating the hologram recording medium with the first light, and a means of irradiating the hologram recording medium with the irradiating signal beam and reference beam each having longer wavelength than said first wavelength after the first light irradiation has been completed.
